(19) United States
(12) Patent Application Publication
(10) Pub. No.: US 2003/0043417 A1
(43) Pub. Date: Mar. 6, 2003

(54) Internet facsimile machine providing voice mail

(76) Inventor: Seung-soo Oak, Gyeonggi-do (KR)

Correspondence Address: STAAS & HALSEY LLP, 700 11TH STREET, NW, SUITE 500, WASHINGTON, DC, 20001, US

(21) Appl. No.: 10/120,777

(22) Filed: Apr. 12, 2002

(30) Foreign Application Priority Data
Aug. 29, 2001 (KR) 2001-52572

(51) Int. Cl. H04N 1/00

(52) U.S. Cl. 358/402

(57) ABSTRACT

An Internet facsimile machine provides a voice mail function of transmitting or receiving voice mail together with a document or voice mail only using an electronic mail transmitting and receiving method and includes a scanner to scan a document to be transmitted, a voice signal processing unit to convert a voice message to be transmitted into digital voice data, a signal conversion unit to convert the scanned document data and/or the digitized voice message to be suitable for an electronic mail transfer standard, and a signal transmission unit to transmit the converted document and/or the converted voice message through the Internet. Accordingly, voice data in addition to a document or image data can be transmitted or received by an Internet facsimile machine or a PC connected to the Internet facsimile machine, thereby offering convenience to users.

### CROSS-REFERENCE TO RELATED APPLICATION

This application claims the benefit of Korean Application No. 2001-52572, filed Aug. 29, 2001, in the Korean Intellectual Property Office, the disclosure of which is incorporated herein by reference.

### BACKGROUND OF THE INVENTION

1. Field of the Invention

The present invention relates to a facsimile machine, and more particularly, to an Internet facsimile machine that provides a voice mail function of transmitting or receiving voice mail together with a document or voice mail using an electronic mail transmitting and receiving method.

2. Description of the Related Art

Generally, a facsimile machine (FAX) is a terminal for the communication of data such as documents or images. The facsimile machine is an apparatus for office automation that transmits or receives the data through a public switched telephone network (PSTN). Since communication through facsimile is widely used, information is frequently interchanged using facsimiles. Particularly, when there is a document which needs to be sent to another location quickly, sending it by facsimile is very effective and greatly improves work efficiency. In addition, with an increase in use of the Internet, the number of Internet facsimile users, which is much cheaper than normal facsimile communication, has increased.

FIG. 1 is a block diagram of a conventional facsimile machine. The facsimile machine includes a scanner 10 to scan a document, a pixel converter 11 to convert data of the scanned document to be suitable for a facsimile protocol, and a modem 12 to convert the data into an analog signal which can be transmitted through a conventional telephone line. A line interface unit (LIU) 13 performs a line impedance and matching function so that a modem signal can be transmitted through the telephone line. A printer 14 prints out a received facsimile document. A controller 15 controls all the modules and a memory 16 stores program data. A personal computer (PC) connection unit 17 transmits or receives the data to or from a PC (not shown) to provide functions such as PC printing and PC scanning. A microphone/speaker 18 and a voice codec 19 convert a voice signal input through the microphone/speaker 18 into a digital signal and convert stored voice digital data into an analog voice signal in order to provide a telephone answering device (TAD) function.

The conventional facsimile machine stores and reproduces an incoming message (ICM) and an outgoing message (OGM) using a normal telephone line. Meanwhile, Internet facsimile machines, which can access an Internet service provider (ISP) and transmit a facsimile document in the form of electronic mail, have been developed by changing the modem 12, which otherwise supports a protocol exclusively used for facsimile machines, into a data modem used for PC communication. Internet facsimile machines convert a conventional, scanned facsimile document into the form of electronic mail, and transmit the document in the form of an attachment file attached to the electronic mail. Thus, the facsimile document can be viewed through a PC as well as printed out as an Internet facsimile.

Conventional Internet facsimile machines have the modem 12 implemented by a data modem allowing transmission of general data. The data modem 12 is essential to transmit a document, which is scanned by an Internet facsimile machine, in the form of electronic mail through an ISP. Point to Point Protocol (PPP) connection is necessary for an Internet facsimile machine to access an ISP using a normal telephone line. The PPP connection can be achieved by using the data modem 12. For transmission of an Internet facsimile document, an image digitized by the scanner 10 is converted into the form of an electronic mail by a multipurpose Internet mail extension (MIME) (not shown) and is then converted into a file format such as a Tagged Image File Format (TIFF). An Internet facsimile machine accesses an ISP through the PPP and transmits the electronic mail to an electronic mail server. The electronic mailer server is connected to the ISP through the Internet, using a protocol such as a Simple Message Transfer Protocol (SMTP). For reception of electronic mail, the Internet facsimile machine accesses an ISP, searches an electronic mail server for new mail using a protocol such as Post Office Protocol version 3 (POP3), downloads the new electronic mail from the electronic mail server, converts it into printable data through the pixel converter 11, and prints the data through the printer 14.

For the TAD function, a voice signal input through the microphone/speaker 18 or the LIU 13 is converted by digital Pulse Code Modulation (PCM) in the voice codec 19. The converted digital voice data is stored in the memory 16. The stored digital voice data is converted into an analog voice signal by the voice codec 19. Thereafter, the voice signal is reproduced through the microphone/speaker 18.

As described above, a conventional Internet facsimile machine simply transmits a document through the Internet, and a conventional TAD function only reproduces or records a voice message stored through a usual telephone line or a microphone.

### SUMMARY OF THE INVENTION

To solve the above and other problems, it is an object of the present invention to provide an Internet facsimile machine that provides a voice mail function of transmitting or receiving voice mail together with a document and/or the voice mail alone using an electronic mail transmitting and receiving method.

It is another object of the present invention to provide a facsimile information transmitting and receiving method of providing a voice mail function of transmitting or receiving voice mail together with a document and/or the voice mail alone using an electronic mail transmitting and receiving method.

Additional objects and advantages of the invention will be set forth in part in the description which follows and, in part, will be obvious from the description, or may be learned by practice of the invention.

To achieve the above and other objects of the invention, an Internet facsimile machine to transmit information converted into the form of electronic mail through the Internet according to an embodiment of the invention includes a scanner to scan a document to be transmitted, a voice signal processing unit to convert a voice message to be transmitted into digital voice data, a signal conversion unit to convert the scanned document data and/or the digitized voice message to be suitable for an electronic mail transfer standard, and a signal transmission unit to transmit the converted document and/or the converted voice message through the Internet.

According to another embodiment of the invention, a method of transmitting information converted into the form of electronic mail through the Internet includes scanning a document to be transmitted, inputting a voice message to be transmitted and converting the inputted voice message into digital data, converting the scanned document data and/or the digitized voice message to be suitable for an electronic mail transfer standard, and transmitting the converted document and/or the converted voice message converted through the Internet.

### BRIEF DESCRIPTION OF THE DRAWINGS

The above and other objects and advantages of the present invention will become more apparent and more readily appreciated by describing in detail preferred embodiments thereof with reference to the accompanying drawings in which:

FIG. 1 is a block diagram of a conventional facsimile machine;

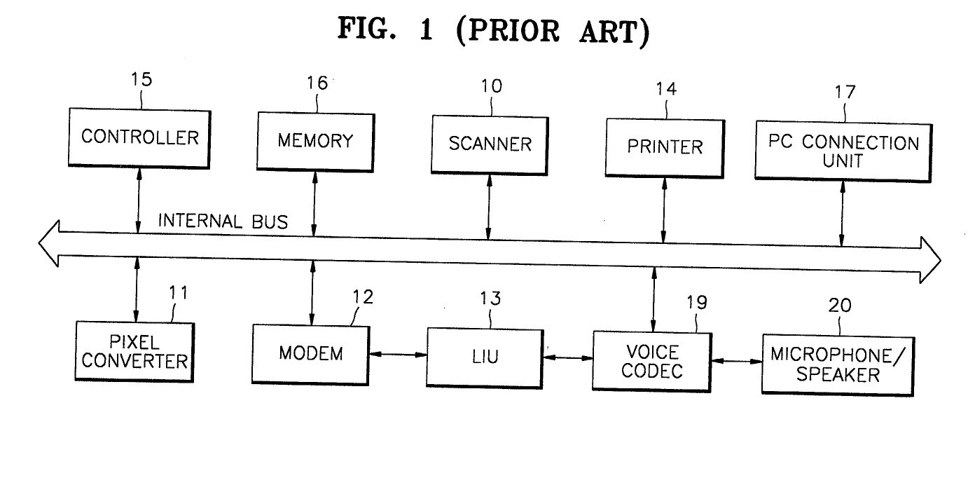

FIG. 2 is a block diagram of an Internet facsimile machine according to an embodiment of the present invention;

FIG. 3 is a detailed diagram of a mail box of FIG. 2;

FIG. 4 is a flowchart of a data transmission method performed by an Internet facsimile machine according to an embodiment of the present invention; and

FIG. 5 is a flowchart of a data receiving method performed by an Internet facsimile machine according to an embodiment of the present invention.

### DETAILED DESCRIPTION OF THE EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

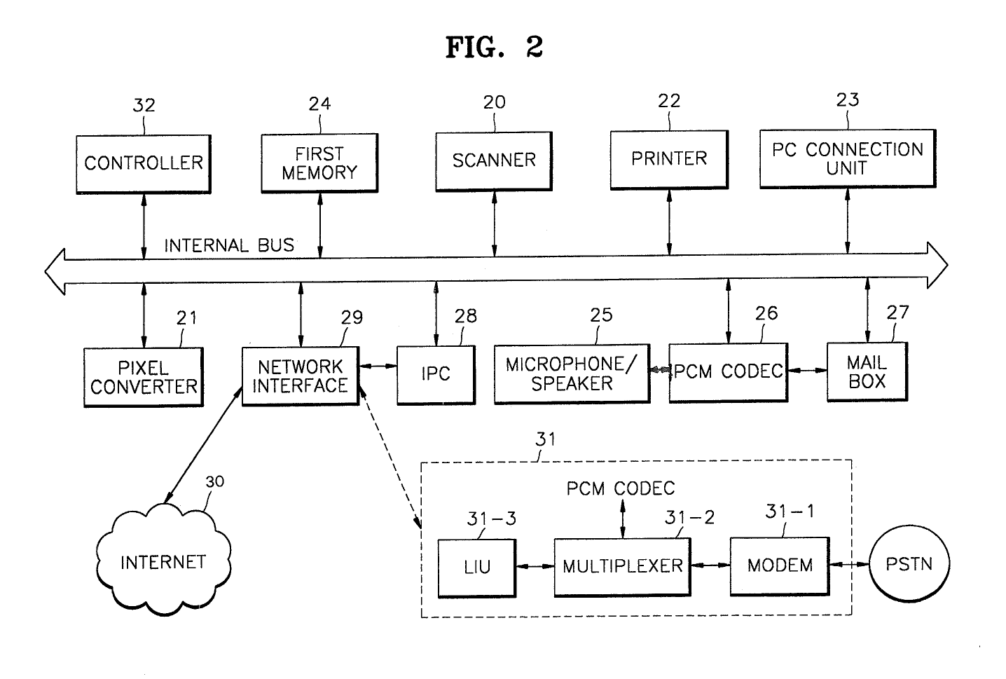

Referring to FIG. 2, an Internet facsimile machine according to an embodiment of the present invention includes a scanner 20, a pixel converter 21, a printer 22, a personal computer (PC) connection unit 23, a first memory 24, a microphone/speaker 25, a Pulse Code Modulator (PCM) codec 26, a mail box 27, an Internet Protocol Controller (IPC) 28, a network interface 29, a telephone network 31, and a controller 32. The telephone network 31 includes a modem 31-1, a multiplexer 31-2, and a line interface unit (LIU) 31-3.

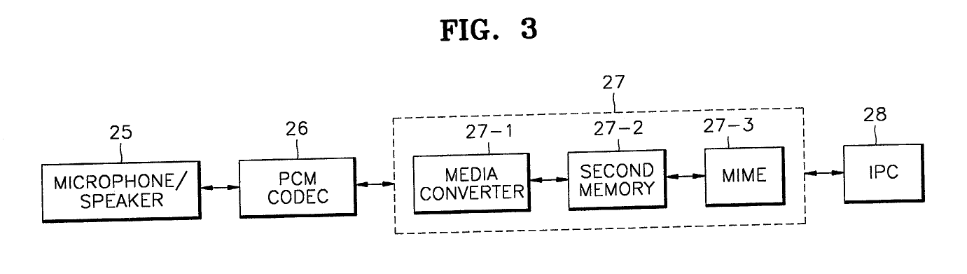

FIG. 3 is a detailed diagram of the mail box 27 of FIG. 2. The mail box 27 includes a media converter 27-1, a second memory 27-2, and a multipurpose Internet mail extension (MIME) 27-3.

Hereinafter, an Internet facsimile machine providing a voice mail function will be described in detail with reference to FIGS. 2 and 3.

The scanner 20 scans a document to be transmitted and converts the scanned document into digital data. Specifically, the scanner 20 projects a bright light onto a sheet of a document to be scanned, photoelectrically converts light reflected from the sheet of the document into an electric signal, and generates image information (figure data) from the electric signal. Figure information obtained from the light reflected from the sheet of a document is input to an optical sensor (not shown) in the form of an analog signal and is amplified. The amplified analog signal is converted into a digital signal by an analog-to-digital converter (not shown). The pixel converter 21 converts scanned document data to be suitable for a facsimile protocol.

The printer 22 prints received document information or prints error information when transmission of a document and/or a voice message ends in failure due to errors in the facsimile machine.

The PC connection unit 23 connects the facsimile machine to a PC (not shown) and performs transmission and reception of the data between the facsimile machine and the PC to reproduce a received document and/or voice message or provide a document scanning function and a voice message recording function.

The first memory 24 stores externally received documents and/or voice messages, documents and/or voice messages to be transmitted, or scanned documents. In addition, the first memory 24 stores programs for controlling the Internet facsimile machine, various kinds of user information, and other data.

The microphone/speaker 25 is connected to the PCM codec 26 to reproduce a received voice message or record a voice message to be transmitted. The PCM codec 26 converts a voice message input through the microphone/speaker 24 into a digital signal or converts a digital voice message to be reproduced into an analog signal and outputs it to the microphone/speaker 25. The PCM codec 26 stores and reproduces an incoming message (ICM) and an outgoing message (OGM) to provide a telephone answering device (TAD) function. The PCM codec 26 converts an analog voice message having temporal continuity into a temporally discrete signal (sampling), expresses the sample value (amplitude) of the discrete signal in a discrete value (quantification), converts the discrete value into a binary or digital signal. The PCM codec 26 also receives an incoming voice message in a binary or digital signal, converts the incoming voice message into an analog signal, and outputs the analog signal to the microphone/speaker 24.

The mail box 27 converts scanned document data and/or a digitalized voice message to be suitable for an electronic mail transport standard. FIG. 3 shows the mail box 27 in detail. The media converter 27-1 converts a voice message input through the microphone/speaker 25 so that the voice message can be reproduced in the computer. At present, a variety of application programs for listening to speech and music are usually installed in a PC, and the media converter 27-1 converts a recorded voice message into a form such as a MIDI file (mid or rmi), a WAVE file (wav), an MP3 file (MPEG Layers I, II, III or other similar MPEG compression techniques), or a REAL file (ra, rm, ram, or pnm) using various digital data compression methods suitable for transmitting audio over the Internet or for storing on storage media. In other words, the media converter 27-1 is a module which compresses and stores a digital voice message in various forms so that the voice message can be reproduced in a PC, and performs a function of forming a digital voice message in various types of audio file formats. It is understood that the mail box 27 could also receive other forms of audio data instead of or in addition to digitized voice data, such as digitized music or other audio input through the microphone 25, the PC connection unit 23, or through separate input ports to be received from portable digital audio devices.

The second memory 27-2 temporarily stores a media-converted digital voice message to become a file attached to a facsimile document. The MIME 27-3 converts a scanned document and/or a media-converted voice message to be suitable for an electronic mail standard. The MIME 27-3 converts a scanned document to comply with an electronic mail standard and, when there is a voice message, attaches the voice message to an electronic mail.

The IPC 28 controls an Internet protocol to transfer a document and/or a voice message having an electronic mail standard. During facsimile information transmission, the IPC 28 transmits a document and/or voice message having an electronic mail standard using a protocol such as a Simple Message Transfer Protocol. During facsimile information reception, the IPC 28 checks whether there is new mail and receives new mail using a protocol such as Post Office Protocol version 3 (POP3).

The network interface 29 transmits facsimile information having an electronic mail standard to the Internet 30 and receives facsimile information having an electronic mail standard from the Internet 30. The network interface 29 may apply a local area network (LAN) access mode or an Internet service provider (ISP) access mode through a public switched telephone network (PSTN), which is performed according to a user's selection. Further, the network interface 29 can communicate with the Internet 30 using wireless techniques.

When a LAN is used for transferring facsimile information, a facsimile machine must be equipped with a LAN card and is directly connected to the Internet 30. In this method, an SMTP or a similar type of protocol is used in addition to a Point to Point Protocol (PPP) in order to transmit the electronic mail, and a reception protocol such as a POP3 is used to receive the electronic mail. Protocol change between, for example, SMTP and POP3 is performed by the IPC 28.

A method of transferring facsimile information using an ISP access mode (using the telephone network 31) through a PSTN is performed by the modem 31-1, the multiplexer 31-2, and the LIU 31-3. The modem 31-1 converts a document and/or a voice message having an electronic mail standard into an analog signal so that the document and/or the voice message can be transmitted through a normal telephone line. Thereafter, The LIU 31-3 performs line impedance and matching on the analog signal which has been processed by the multiplexer 31-2 so that the analog signal can be transmitted through a telephone line. The resulting signal is transmitted to the Internet 30 through the network interface 29.

More specifically, the Internet facsimile machine dials an ISP providing an Internet access function for connection to an electronic mail server. The Internet facsimile machine accesses the ISP using a PPP. After the Internet facsimile machine is connected to the ISP, it transmits a scanned document in the form of electronic mail using a protocol such as an SMTP for transmission of electronic mail. Here, a voice message stored together with the scanned document is transmitted as an attachment of the electronic mail. When a facsimile machine receiving a document file prints the document file, an audio file received as an attachment is stored in the first memory 24. According to a user's operation, a medium for the audio file can be converted, the converted audio file can be converted into an analog signal by the PCM codec 26 and reproduced through the microphone/speaker 25. In addition, the audio file can be reproduced in a PC using various existing application programs such as Media Player and Real Audio.

The controller 32 controls all of the modules of the Internet facsimile machine. The controller 32 according to an embodiment of the present invention includes a computer that implements the modules using a computer program encoded on a computer readable medium such as the first memory 24.

Basically, the Internet facsimile machine uses an existing electronic mail transfer method to transmit both a facsimile document and/or various types of multimedia files such as voice and audio files.

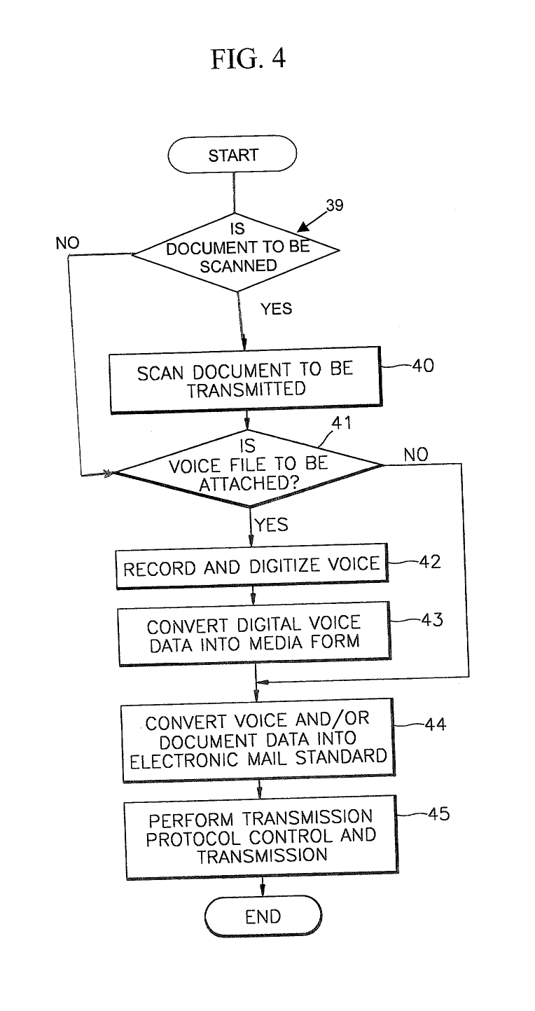

FIG. 4 is a flowchart of a data transmission method performed by an Internet facsimile machine according to an embodiment of the present invention. The data transmission method includes determining whether to scan a document (operation 39). If a document is to be scanned, scanning a document to be transmitted (operation 40). Whether a document has or has not been scanned, determining whether a voice file is to be attached (operation 41), recording and digitizing a voice (operation 42), converting digital voice data into a media form (operation 43), converting voice and/or document data into an electronic mail standard (operation 44), and performing transmission protocol control and transmission (operation 45). It is understood that the above order can in determining whether to scan the document or to record the voice message can be performed in reverse order.

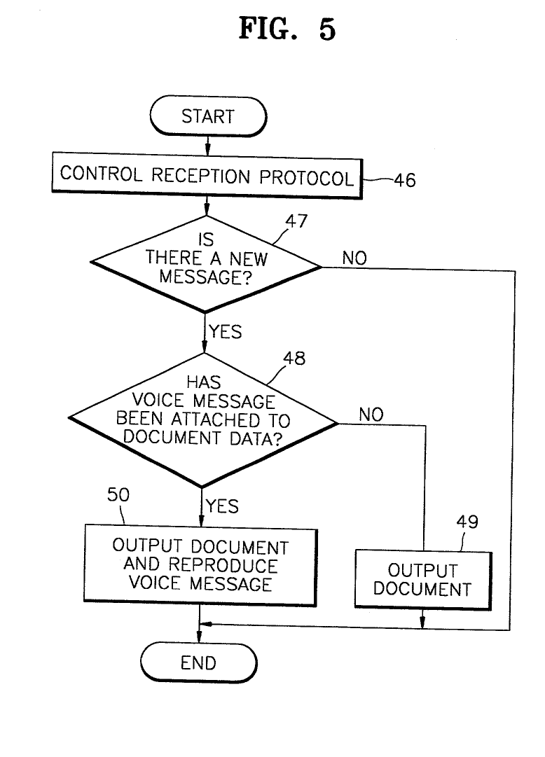

FIG. 5 shows a data receiving method performed by an Internet facsimile machine according to an embodiment of the present invention. The data receiving method includes controlling a reception protocol (operation 46), determining whether a new message has been received (operation 47), determining whether a voice message has been attached to document data (operation 48), outputting a document (operation 49), and outputting the document and reproducing the voice message (operation 50).

Hereinafter, a method of transmitting and receiving information performed by an Internet facsimile machine providing a voice mail function will be described with reference to FIGS. 4 and 5.

A user scans a document to be transmitted using the scanner 20 (operation 40). While scanning the document, the scanner 20 converts the document into digital data. The pixel converter 21 converts the scanned digital document data to be suitable for a facsimile protocol.

After scanning the document, it is determined whether a voice file is to be attached to the document (operation 41). If it is determined that a voice file is to be attached, voice or other audio is input through the microphone/speaker 25 and is recorded and digitized (operation 42). If a voice message to be transmitted is recorded through the microphone/speaker 25, the PCM codec 26 digitizes the recorded voice message. However, it is understood that where the audio to be transmitted has already been digitized, such as in music or prerecorded audio, the microphone/speaker 25 might not be used.

The digitized voice message is converted into a form of media (operation 43). Conversion into a form of media is performed by the media converter 27-1 of the mail box 27. The media converter 27-1 converts the voice message input through the microphone/speaker 25 so that the voice message can be reproduced in the computer. At present, a variety of application programs for listening to speech and music are usually installed in a PC. Thus, the media converter 27-1 converts a recorded voice message into a form such as a MIDI file (mid or rmi), a WAVE file (wav), an MP3 file (MPEG Layer I, II, III or any other suitable MPEG style compression), or a REAL file (ra, rm, ram, or pnm) using various digital compression methods. In other words, the media converter 27-1 is a module which can compress and store a digital voice message in various forms so that the voice message can be reproduced in a PC, and performs a function of forming a digital voice message in various types of audio file. However, if the audio file has already been converted, the media converter 27-1 would not need to convert the audio file unless it is desired to change the audio format.

After completion of conversion into a form of media, the voice and/or the document data is converted into an electronic mail standard (operation 44). If a voice file is not attached, the scanned document data is converted into the electronic mail standard. If a voice file is attached, the scanned document data is converted into the electronic mail standard and then the voice file is attached to the converted document data. Conversion into the electronic mail standard is performed by the MIME 27-3 of the mail box 27. The MIME 27-3 converts the scanned document and/or media-converted voice message into the electronic mail standard. Specifically, the MIME 27-3 converts the document data into a file format such as a tagged image file format (TIFF) and converts the voice message into an attached file format. The MIME 27-3 converts a scanned document into the electronic mail standard and when there is a voice message, attaches the voice message to the electronic mail resulting from the conversion by the media converter 27-1.

To transmit the electronic mail to the Internet, the IPC 28 controls a transmission protocol and transmits the electronic mail (operation 45). When transmitting facsimile information, the IPC 28 transmits a document and/or a voice message, which have been converted into an electronic mail standard, using a protocol such as SMTP. A method of transmitting facsimile information using a LAN is performed when a facsimile machine is equipped with a LAN card. In this embodiment, the facsimile machine is directly connected to the Internet 30, and an SMTP or a similar type of protocol is used in addition to a PPP for transmission of electronic mail.

In a method of transmitting facsimile information using an ISP access mode through a PSTN according to an embodiment of the invention, an Internet facsimile machine dials an ISP providing an Internet access function for connection to an electronic mail server. The Internet facsimile machine accesses the ISP using a PPP. After the Internet facsimile machine is connected to the ISP, it transmits a scanned document and/or a voice file attached to the scanned document in the form of electronic mail using a protocol such as an SMTP for transmission of electronic mail. Transmission of the electronic mail (i.e., facsimile information) is carried out by operating buttons (not shown) on an operation panel (not shown) generally located on the surface of the facsimile machine. A user can input the telephone number or electronic mail address of a receiving party by operating buttons on the operation panel. The input telephone number or electronic mail address can be selectively stored in the first memory 24.

The facsimile machine automatically accesses a mail server at regular time intervals and checks whether there is new mail (operation 47). The regular time intervals can be set by default or set by a user's selection. Further, the facsimile machine can check the mail server at a command of the user outside of these regular time intervals. Here, the IPC 28 controls a reception protocol (operation 46). The IPC 28 checks whether there is new mail and receives the new mail using a protocol such as a POP3. Methods of receiving facsimile information are differentiated based on which one of a LAN access mode and an ISP access mode through a PSTN is used.

A method of receiving facsimile information using a LAN is performed when the facsimile machine is equipped with a LAN card. In this embodiment, the facsimile machine is directly connected to the Internet 30. In this method, a reception protocol such as a POP3 is used in addition to a PPP for reception of electronic mail.

In a method of receiving facsimile information using an ISP access mode through a PSTN, an Internet facsimile machine dials an ISP providing an Internet access function for connection to an electronic mail server. In this embodiment, the Internet facsimile machine accesses the ISP using a PPP. After the Internet facsimile machine is connected to the ISP, it receives a scanned document in the form of electronic mail using a protocol such as a POP3 for reception of electronic mail.

It is determined whether a voice message has been attached to document data (operation 48). If it is determined that only document data is received in the form of electronic mail, the received document is output (operation 49). Output of the received document can be performed on a PC as well as a facsimile machine. When a received document is checked on a facsimile machine, the document can be output through the printer 22. When a received document is checked on a PC, the document can be output through a printer (not shown) or stored in a built-in memory after being reproduced.

If it is determined that a voice file has been attached to electronic mail (operation 48), the received document and voice message are checked and reproduced (operation 50). The received document and the voice message can be checked on a PC as well as a facsimile machine. When the received document and voice message are checked in the facsimile machine, the received document is output through the printer 22, while the voice message is media-converted by the media converter 27-1, is converted into an analog signal by the PCM codec 26, and is output through the microphone/speaker 25. When the received document and voice message are checked on a PC, the received document is output through a printer (not shown), and the voice message undergoes voice signal conversion in the PC and is reproduced through another speaker (not shown). Alternatively, the document and the voice message can be stored in a built-in memory (not shown).

Basically, the Internet facsimile machine of the present invention uses an existing electronic mail transfer method to transmit a facsimile document along with voice and audio files. However, it is understood that voice data could also include other data, such as recorded video data or audio data, which can be attached in addition to or instead of the voice data.

According to the present invention described above, voice data in addition to a document or image data can be transmitted or received by an Internet facsimile machine or a PC, thereby offering convenience to users. While discussed in terms of electronic mail, it is further understood that the Internet facsimile machine could also be used with other electronic messaging systems, such as Peer-to-Peer systems or Instant Messaging systems instead of or in addition to electronic mail.

This invention is not restricted to the above-described preferred embodiments, and it will be understood by those skilled in the art that various changes in form and details may be made therein without departing from the principles and spirit of the invention, the scope of which is defined in the claims and their equivalents.

What is claimed is:

1. An Internet facsimile machine to transmit information converted into the form of electronic mail through the Internet, the Internet facsimile machine comprising:
a scanner to scan a document to be transmitted as document data;
a voice signal processor to convert a voice message to be transmitted into a digital voice message;
a signal converter to convert the document data and the digital voice message into a form suitable for an electronic mail transfer standard; and
a signal transmitter to transmit the converted document data and the converted digital voice message through the Internet.

2. The Internet facsimile machine of claim 1, further comprising a reproducing unit to reproduce another document data and/or another digital voice message received over the Internet.

3. The Internet facsimile machine of claim 2, further comprising a computer interface that allows the another document data and/or the another digital voice message to be received and reproduced by a computer.

4. The Internet facsimile machine of claim 1, wherein said signal converter comprises:
a first converter to convert the digital voice message into another format suitable for reproduction by a computer; and
a second converter to convert the document data and the digital voice message output from the first converter into the format suitable for the electronic mail transfer standard.

5. The Internet facsimile machine of claim 4, wherein said signal transmitter controls a protocol for the document data and the digital voice message output from the second converter and has the electronic mail transfer standard, to perform Internet transmission.

6. The Internet facsimile machine of claim 5, wherein the protocol is selected from a first protocol to transmit the document data and the digital voice message through a telephone network to the Internet and a second protocol to directly transmit the document data and the digital voice message to the Internet.

7. A method of transmitting information converted into the form of electronic mail through the Internet, the method comprising:
scanning a document to be transmitted to provide document data;
inputting a voice message to be transmitted and converting the input voice message into digital data to provide a digital voice message;
using a facsimile machine, converting the document data and the digital voice message to a format suitable for an electronic mail transfer standard; and
transmitting the converted document data and the converted digital voice message through the Internet.

8. The method of claim 7, further comprising receiving and reproducing another document data and/or a digital voice message.

9. The method of claim 8, wherein the another document data and/or the another digital voice message are received and reproduced by a computer.

10. The method of claim 7, wherein said converting comprises:
converting the document data and the digital voice message into another format suitable for being reproduced by a computer; and
converting the document data and the digital voice message converted to be reproduced by the computer into the format suitable for the electronic mail transfer standard.

11. The method of claim 7, wherein said transmitting comprises controlling a protocol for the converted document data and the converted digital voice message having the electronic mail transfer standard and performing Internet transmission.

12. The method of claim 11, wherein the protocol is selected from a first protocol for transmitting the converted document data and the converted digital voice message through a telephone network to the Internet and a second protocol for directly transmitting the converted document data and the converted digital voice message to the Internet.

13. A method of transmitting information converted into an electronic message sent through the Internet, the method comprising:
if audio data is received, converting the received audio data into digital audio data in a format suitable to be transferred with a message over the Internet using a facsimile machine; and
sending the message including scanned document data and the converted digital audio data from the facsimile machine through the Internet.

14. The method of claim 13, further comprising:
scanning a document to provide the scanned document data;
converting the scanned document data into the format suitable to be transferred with the message over the Internet; and
transmitting the converted scanned document data and the converted digital audio data through the Internet.

15. The method of claim 13, further comprising:
checking if the audio data is received prior to said converting the received audio data; and
if the audio data is not received, sending the message including the scanned document data from the facsimile machine over the Internet.

16. The method of claim 13, wherein said converting the received audio comprises compressing the audio data into one of a MIDI file, a WAVE file, an MPEG file, and a REAL file.

17. The method of claim 16, wherein:
the audio data is received as a voice message through a microphone included with the facsimile machine, and
said converting the audio data comprises converting the voice message into the digital audio data.

18. The method of claim 16, wherein the audio data is received through an interface with an external device.

19. The method of claim 18, wherein said converting the received audio comprises compressing the audio data into one of a MIDI file, a WAVE file, an MPEG file, and a REAL file.

20. The method of claim 18, wherein the audio data is converted prior to being received through the interface.

21. An Internet facsimile machine to transmit information converted into the form of electronic mail through the Internet, the Internet facsimile machine comprising:
a scanner to scan a document to be transmitted as document data;
an audio processor to convert received audio data to be transmitted as digital audio data;
a media converter to convert the document data and the digital audio data into a suitable form for transfer through the Internet; and
a signal transmitter to transmit one of the converted document data and the converted digital audio data received from said media converter to be transmitted through the Internet.

22. The Internet facsimile machine of claim 21, where said signal transmitter receives the converted document data and the converted digital audio data, and transmits the converted document data and the converted digital audio data in a message.

23. The Internet facsimile machine of claim 22, where the message is an electronic mail message.

24. The Internet facsimile machine of claim 20, wherein said media converter comprises an encoder that compresses the digital audio data.

25. The Internet facsimile machine of claim 24, wherein the compressor compresses the digital audio data into one of a MIDI file, a WAVE file, an MPEG file, and a REAL file.

26. The Internet facsimile machine of claim 20, further comprising a microphone to receive a voice message as audio data to be processed by said audio processor.

27. The Internet facsimile machine of claim 26, wherein said media converter comprises:
an encoder that compresses the digital audio data,
a memory to store the compressed digital audio data, and
a second encoder to encode the compressed digital audio data received from the memory into the suitable format for transfer through the Internet.

28. The Internet facsimile machine of claim 21, further comprising a printer and a speaker,
wherein:
said signal transmitter further receives another document data and another audio data from the Internet, and
said media converter converts the another document data to be printed to said printer, and converts the another audio data to be reproduced through said speaker.

29. The Internet facsimile machine of claim 21, further comprising an interface, wherein:
said signal transmitter further receives another document data and another audio data from the Internet and outputs the another document data and the another audio data to an external device through said interface.

30. A computer readable medium encoded with processing instructions for implementing a method of transmitting information converted into an electronic message sent through the Internet performed by a computer, the method comprising:
after a scanned document data is received, checking whether audio data is received;
if the audio data is received,
converting the received audio data into digital audio data in a format suitable to be transferred with a message over the Internet using a facsimile machine, and
sending the message including the scanned document data and the digital audio data from the facsimile machine through the Internet; and
if the audio data is not received,
sending the message including the scanned document data from the facsimile machine through the Internet.

31. The computer readable medium of claim 30, wherein said converting the received audio comprises compressing the audio data into one of a MIDI file, a WAVE file, an MPEG file, and a REAL file.

32. The computer readable medium of claim 30, wherein:
the audio data is received as a voice message from a microphone included with the facsimile machine, and
said converting the audio data comprises converting the voice message into the digital audio data.

33. The computer readable medium of claim 30, wherein the audio data is received through an interface with an external device.

34. The computer readable medium of claim 33, wherein said converting the received audio comprises compressing the audio data into one of a MIDI file, a WAVE file, an MPEG file, a REAL file.

35. The computer readable medium of claim 33, wherein the audio data is converted prior to being received through the interface.

36. A computer readable medium encoded with processing instructions for implementing a method of receiving information converted into an electronic message and sent through the Internet performed by a computer, the method comprising:
checking with a message server to detect a new message;
if the new message exists, retrieving the new message; and
checking whether the new message includes audio data in addition to document data;
if there is audio data, outputting the audio data to be decoded by a facsimile machine or to be output through an interface to an external device.

37. The computer readable medium of claim 36, wherein said outputting the audio data comprises reproducing the audio data using the facsimile machine and printing the document data.

38. The computer readable medium of claim 37, wherein the reproducing the audio data comprises decompressing the audio data to be reproduced.

39. The computer readable medium of claim 36, wherein said outputting the audio data comprises outputting the audio data through the interface prior to decoding the audio data.

40. A method of transmitting information converted into an electronic message sent through the Internet, the method comprising:
determining whether a document is to be scanned, and scanning the document if the document is to be scanned;
if audio data is received, converting the received audio data into digital audio data in a format suitable to be transferred with a message over the Internet using a facsimile machine; and
sending the message including the scanned document, if the document is to be scanned, and the converted digital audio data from the facsimile machine through the Internet.
